(19) United States
(12) Patent Application Publication
(10) Pub. No.: US 2006/0237998 A1
(43) Pub. Date: Oct. 26, 2006

(54) Stop support for the front hood of a motor vehicle

(75) Inventors: Gérald Andre, Ambrieu En Bugey (FR); Pascal Carrier, Lyon (FR); Alexis Lepoutre, Cremieu (FR)

Correspondence Address: EPSTEIN DRANGEL BAZERMAN & JAMES, LLP, 60 EAST 42ND STREET, SUITE 820, NEW YORK, NY, 10165, US

(73) Assignee: Compagnie Plastic Omnium, Lyon (FR)

(21) Appl. No.: 10/564,933

(22) PCT Filed: May 4, 2005
(86) PCT No.: PCT/FR05/01134

§ 371 Date: Jan. 13, 2006

(30) Foreign Application Priority Data
May 12, 2004 (EP) 04291217.0

(51) Int. Cl. B62D 25/12

(52) U.S. Cl. 296/193.11

(57) ABSTRACT

The invention relates to a support (22) for an abutment (24) for a hood at the front of a motor vehicle. In the closed position, the hood bears against the abutment (24). The support (22) is suitable for giving way when the hood is subjected to a substantially vertical force greater than a predetermined threshold corresponding to the force that results from an impact against a pedestrian. The invention also provides a front hood carrier. The invention also provides any motor vehicle part (16) provided with such a support (22), and in particular a front panel cross-member (16), a front panel cross-member cover (18), a bumper strength member (12), and a bumper skin (14).

The present invention relates to an abutment support for the hood at the front of a motor vehicle, the hood, when in the closed position, bearing on the abutment.

As a result of an impact with a pedestrian at the front of a motor vehicle, the head or the femur of the pedestrian can come into collision at high speed with the front hood following a trajectory that is substantially vertical. The hood turns about a horizontal axis via hinges located at the rear of the hood, and it flattens vertically at the front.

Unfortunately, in the closed position, the hood bears at the front on at least one abutment that is generally disposed on a front cross-member of the motor vehicle, said cross-member being very rigid by construction.

The injuries that arise from such a collision are particularly severe, in that the head is subjected to high negative acceleration as it is decelerated down to zero speed.

This negative acceleration depends on the reaction force exerted by the hood and on the stroke available for deceleration purposes before the head is stopped by a very rigid part of the motor vehicle, such as the cross-member.

In order to protect the pedestrian, it is desirable for the reaction force exerted by the hood to be limited, while still serving to bring the head to rest over the stroke that is available for deceleration.

When the abutments are likewise rigid, the reaction force on the pedestrian's head is very large. Mere deformation of the hood during the collision does not suffice to limit the reaction force sufficiently.

Thus in order to limit the reaction force, it is known to use an abutment provided with a spring that allows the hood to be pushed in during the collision.

However such abutments are complex and particularly expensive.

An object of the invention is to provide a simple and inexpensive device that enables a pedestrian's head to be preserved without recourse to such spring abutments.

To this end, the invention provides a support for an abutment of a motor vehicle having a front hood that, in the closed position, bears against the abutment, the support being characterized in that it is suitable for giving way when the hood is subjected to a substantially vertical force greater than a predetermined threshold corresponding to the force resulting from an impact with a pedestrian.

Thus, by means of the invention, a deceleration stroke and a limitation on the reaction force are obtained in a manner that is simple by selecting a support of a shape and a type of material that give it the ability to give way. In addition, it is very easy to fasten conventional abutments to such a support.

Optionally, the abutment support is integrally molded with a part of the motor vehicle.

This shortens the chain of dimensions between the hood and the bodywork part, thereby improving management of clearances between the hood and the bodywork parts located around the hood.

An abutment support of the invention may also include one or more of the following characteristics:
it is suitable for giving way by deforming plastically;
its deformation is programmed in such a manner as to maintain an acceptable reaction force, i.e. close to the predetermined threshold, by having a particular geometrical shape;
it is suitable for giving way by breaking; and
it is made of plastics material.

The invention also provides a carrier for a motor vehicle front hood, the carrier being of the type including an abutment against which the front hood bears when in the closed position, the carrier being characterized in that it includes an abutment support of the invention.

The invention also provides a motor vehicle part provided with an abutment support of the invention.

The invention also provides a front panel cross-member provided with an abutment support of the invention.

The invention also provides a front panel cross-member cover provided with an abutment support of the invention.

The invention also provides a bumper strength member provided with an abutment support of the invention.

Finally, the invention provides a bumper skin provided with an abutment support of the invention.

The invention will be better understood on reading the following description given purely by way of example and made with reference to the accompanying drawings, in which:

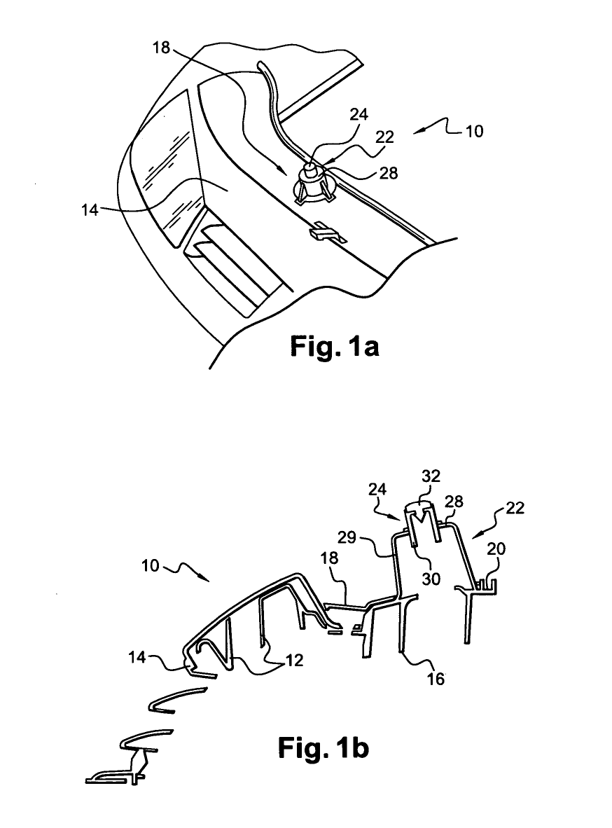

FIG. 1a is a perspective view of the front of a motor vehicle showing a front panel cross-member provided with an abutment support constituting a first embodiment of the invention;

FIG. 1b is a longitudinal section view of the FIG. 1a motor vehicle front;

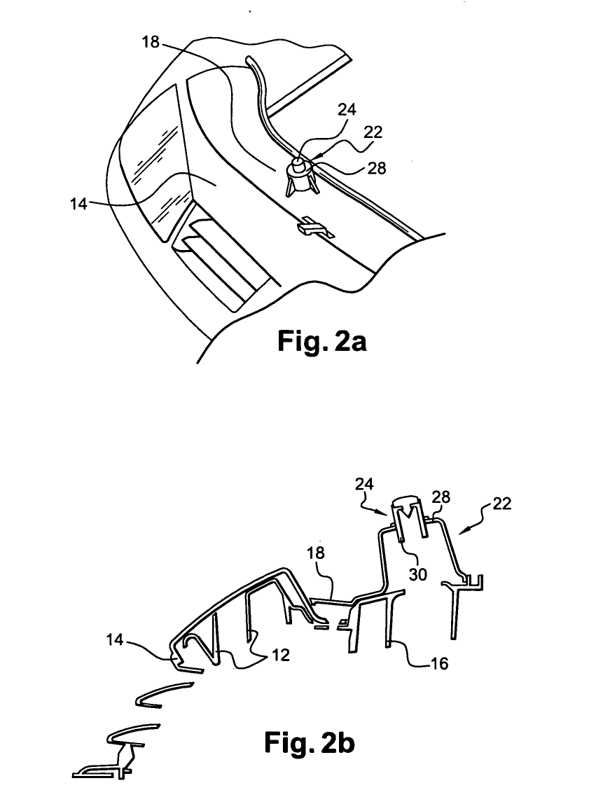

FIG. 2a is a perspective view of the front of a motor vehicle showing a front panel cover provided with an abutment support constituting a second embodiment of the invention;

FIG. 2b is a longitudinal section view of the FIG. 2a motor vehicle front;

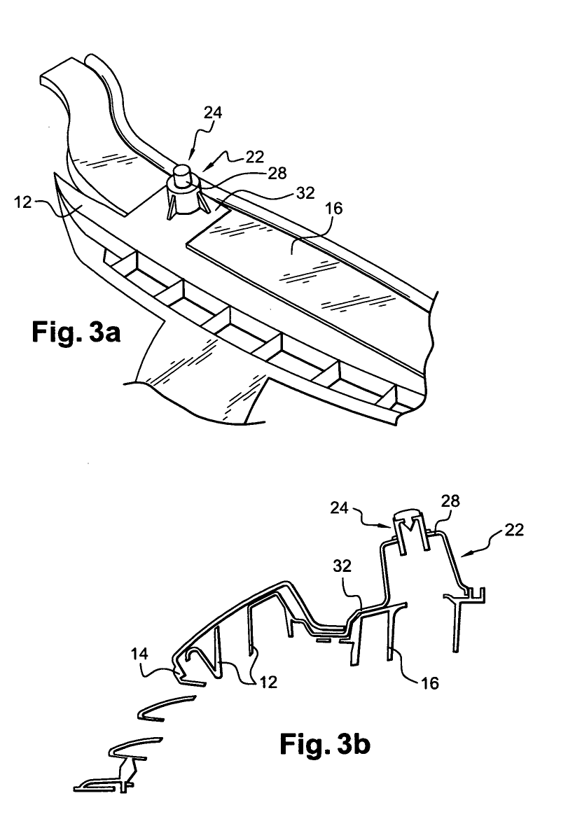

FIG. 3a is a perspective view of the front of a motor vehicle showing a bumper strength member provided with an abutment support constituting a third embodiment of the invention;

FIG. 3b is a longitudinal section of the FIG. 3a motor vehicle front;

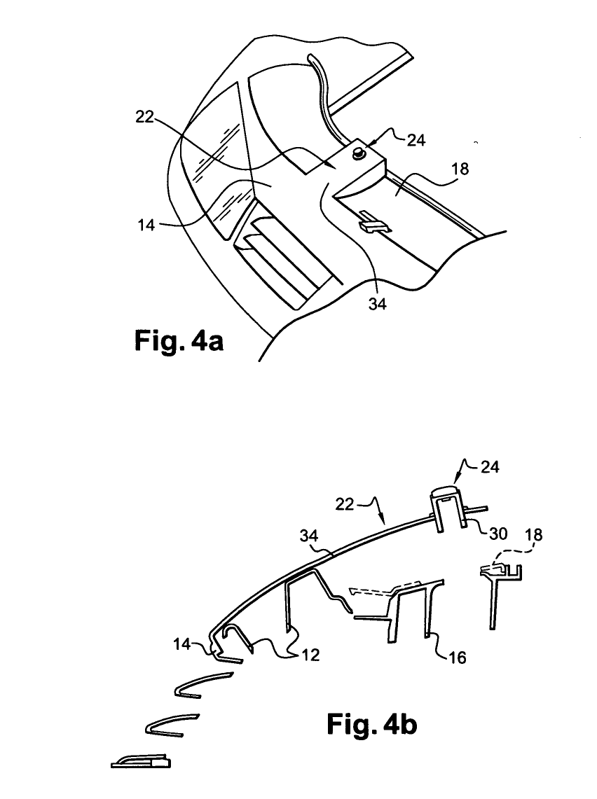

FIG. 4a is a perspective view of the front of a motor vehicle showing a front bumper skin provided with an abutment support constituting a fourth embodiment of the invention; and

FIG. 4b is a longitudinal section view of the FIG. 3a motor vehicle front.

FIGS. 1a and 1b show a motor vehicle front given overall reference 10. The front 10 of the motor vehicle includes a bumper strength member 12 and a bumper skin 14. The bumper skin 14 is supported by the bumper strength member 12 and covers it.

The motor vehicle front 10 also includes a front panel having a cross-member 16 extending across the width of the vehicle and shown in FIG. 1b. The bumper strength member 12 and the bumper skin 14 extend up to the cross-member 16.

The cross-member 16 is also covered in part by a cross-member cover 18 that extends in the length direction of the vehicle from the bumper skin 14 in front to a rib 20 of the cross-member 16 behind.

The cross-member 16 comprises a support 22 for an abutment 24 of a front hood (not shown) of the motor vehicle. The cross-member 16 and the support 22 are made of plastics material.

The support 22 is obtained from the same molding operation as the cross-member 16. Thus the support 22 is created by forming a wall of the cross-member 16 into the shape of a truncated cone, having a plane top portion 28 connected to side portions 29 serving to support the abutment 24. The abutment generally comprises a cylindrical body 30 going through the plane portion 28 with a pad 32 obstructing a top end of the cylinder 30, and against which the front hood bears when in the closed position.

The cross-member cover 18 covering the cross-member 16 has a circular opening through which the support 22 projects.

When the hood is subjected to a force that is substantially vertical and greater than a predetermined threshold, corresponding to the force that results from an impact against a pedestrian, the support 22 is suitable for giving way by deforming plastically.

More precisely, when the abutment 24 is pushed in under the effect of a vertical force, the top plane portion 28 becomes deformed and sags in the vicinity of the abutment 24, and the side portions 29 buckle accordingly.

Deformation initially takes place elastically, with a small amount of deformation giving rise to a large increase in the reaction force. This elastic deformation makes the support 22 suitable for withstanding without permanent deformation stresses associated with the hood being sat on or being repeatedly slammed shut. Thereafter deformation takes place plastically, with very little increase in the reaction force as a function of deformation: the support 22 is then said to give way.

By an appropriate choice of material and geometrical shape for the support, deformation can be programmed so as to maintain a reaction force that is substantially equal to the predetermined threshold.

In a variant, the support 22 may give way by breaking partially instead of by deforming plastically.

FIGS. 2a and 2b show a second embodiment of the invention. Parts that are analogous to those described for the first embodiment of FIGS. 1a and 1b are given the same references.

In this embodiment, the bumper strength member 12 and the bumper skin 14 are identical to those of the first embodiment.

In this case, the support 22 is integrally molded with the cross-member cover 18 that covers the cross-member 16. Thus, the support 22 is created by forming a wall of the cross-member cover 18 to be a truncated cone, with a plane top portion 28 supporting the abutment 24. The abutment is identical to that described for the first embodiment.

FIGS. 3a and 3b show a third embodiment of the invention. Parts identical to those described for the above embodiments are given the same references.

In this third embodiment, the bumper strength member 12 has a wall 32 covering the cross-member 16. The support 22 is created by forming the wall 32 of the cross-member 16 to have a truncated cone shape with a top plane portion 28 supporting the abutment 24.

FIGS. 4a and 4b show a fourth embodiment of the invention. Parts that are analogous to those described for the above embodiments are given the same references.

In the fourth embodiment, the bumper skin 14 has an extension 34 extending over the cross-member 16 and its cover 18. The extension 34 is integrally molded with the bumper skin 14 in continuity with an outside surface of the bumper skin 14, i.e. a surface that is visible.

The extension 34 is in the form of a plane rectangle extending at a distance from the cross-member 16 substantially parallel to a top wall of the cross-member 16.

The extension 34 has one end connected to the bumper skin and another end opposite to said one end. The extension 34 is connected to the cross-member 16 by means of two substantially vertical side edges (not shown) placed between its two ends. The side edges are also part of the same molding as the bumper skin 14.

The entire extension 34 together with its side edges constitutes the support 22 for the abutment 24. The abutment 24 is identical to that described for the above embodiments, except that the cylinder 30 passes through the extension 34 in this fourth embodiment.

It should be observed that the invention is not limited to the embodiments described.

In particular, the support may be integrally molded with other parts of the motor vehicle, and it may have shapes other than those described, providing they give it the same properties as those described.

1. A support (22) for an abutment (24) of a motor vehicle having a front hood that, in the closed position, bears against the abutment (24), the support being characterized in that it is suitable for giving way when the hood is subjected to a substantially vertical force greater than a predetermined threshold corresponding to the force resulting from an impact with a pedestrian.

2. An abutment support (22) according to claim 1, characterized in that it is suitable for giving way by deforming plastically.

3. An abutment support (22) according to claim 2, in which its deformation is programmed in such a manner as to maintain an acceptable reaction force, i.e. close to the predetermined threshold, by having a particular geometrical shape.

4. An abutment support (22) according to any one of claims 1 to 3, characterized in that it is suitable for giving way by breaking.

5. An abutment support (22) according to any one of claims 1 to 4, characterized in that it is made of plastics material.

6. An abutment support (22) according to claim 5, in which the support is integrally molded with a part (16; 18; 12; 14) of the motor vehicle.

7. A carrier for a motor vehicle front hood, the carrier being of the type including an abutment (24) against which the front hood bears when in the closed position, the carrier being characterized in that it includes an abutment support (22) according to any one of claims 1 to 6.

8. A motor vehicle part (16; 18; 12; 14) provided with an abutment support (22) according to any one of claims 1 to 6.

9. A front panel cross-member (16) provided with an abutment support (22) according to any one of claims 1 to 6.

10. A front panel cross-member cover (18) provided with an abutment support (22) according to any one of claims 1 to 6.

11. A bumper strength member (12) provided with an abutment support (22) according to any one of claims 1 to 6.

12. A bumper skin (14) provided with an abutment support (22) according to any one of claims 1 to 6.
